(19) United States
(12) Patent Application Publication
(10) Pub. No.: US 2010/0247905 A1
(43) Pub. Date: Sep. 30, 2010

(54) Stiky add roll

(76) Inventor: John Frederick Ringlein, Naperville, IL (US)

Correspondence Address: John Ringlein, Suite D, 175 E. Crossroads, Bolingbrook, IL, 60440, US

(21) Appl. No.: 12/383,600

(22) Filed: Mar. 27, 2009

(51) Int. Cl. B32B 7/12

(52) U.S. Cl. 428/343

(57) ABSTRACT

The present invention relates to 2¼″ wide printing calculator paper with non-permanent sticky adhesive backing. With an adhesive strip on the entire length of the paper, any portion used will have the ability to adhere to surfaces. The invention is applicable to all types of paper including regular or bonded paper and thermal paper. The width of 2¼″ is critical to the invention because other size paper is not compatible with standard printing calculators.

### CROSS-REFERENCE TO RELATED APPLICATIONS

Not applicable

### STATEMENT REGARDING FEDERALLY SPONSORED RESEARCH OR DEVELOPMENT

Not applicable

### REFERENCE TO SEQUENCE LISTING, A TABLE, OR A COMPUTER PROGRAM LISTING COMPACT DIS APPENDIX

Not applicable

### BACKGROUND OF THE INVENTION

Printing calculators have long been known and widely used. Over time, printers with 2¼″ wide paper have become the standard. An internet search on Mar. 19, 2009 found all printing calculators available for purchase in the United States to use 2¼″ paper.

Three types of printers are widely available; ribbon printers, ink roller printers, and thermal printers. Ribbon printers and ink roller printers use regular or bond paper. Thermal printers use thermal paper. Paper used in printing calculators is often referred to as “Add Rolls”, “Adding Machine Rolls”, “Calculator Rolls”, or “Calculator Paper”.

Printing calculator users often save the results of their printed calculations. The paper is taped or stapled to a surface or other documents, attached to other documents with a paper clip, or stored loose in a folder or placed on a surface. Users also feed blank paper through the calculator to obtain small blank paper for notes.

Although such methods have succeeded for many years, a need for a simpler method to retain printed calculations and blank paper feeds that do not involve additional materials such as tape, staples, and clips has been identified.

### BRIEF SUMMARY OF THE INVENTION

The present invention relates to 2¼″ wide printing calculator paper with non-permanent sticky adhesive backing. With an adhesive strip on the entire length of the paper, any portion used will have the ability to adhere to surfaces. The invention is applicable to regular or bonded paper and thermal paper. The width of 2¼″ is critical to the invention because other size paper is not compatible with standard printing calculators.

### BRIEF DESCRIPTION OF THE SEVERAL VIEWS OF THE DRAWING

FIG. 1 is a side view of the present invention.

### DETAILED DESCRIPTION OF THE INVENTION

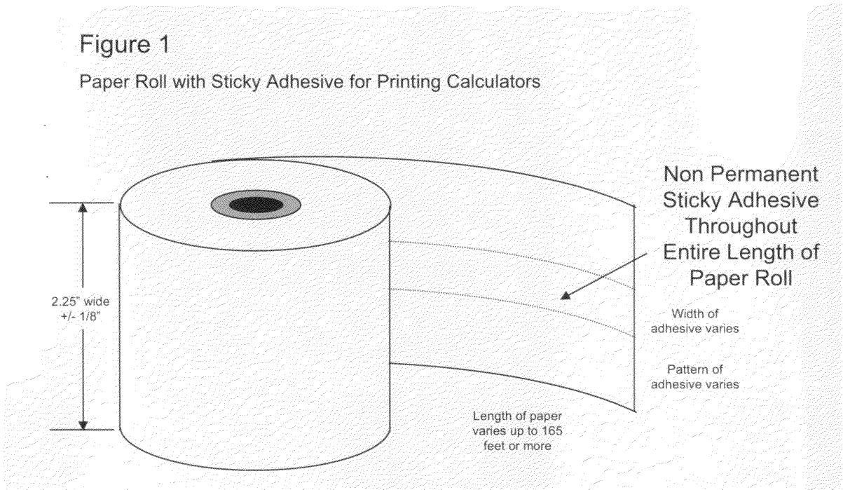

The present invention relates to 2¼″ wide printing calculator paper with non-permanent sticky adhesive backing. With an adhesive strip on the entire length of the paper (see FIG. 1), any portion used will have the ability to adhere to surfaces. The invention is applicable to any type of paper used in printing calculators including regular or bonded paper and thermal paper.

Paper will be provided by a paper mill. As the paper is rolled onto a core, the non permanent sticky adhesive will be applied. The paper will be cut to a 2¼″ width (plus or minus ⅛″) to accommodate printing calculators. As the paper is unwound and used in the printing calculator, the paper will feed through the printer for printing or blank usage. After printing or feeding the paper, the user will tear the paper from the printing calculator and stick the paper to other documents or surfaces.

The 2¼″ wide paper may also be used outside of the calculator as a sticky note of any length.

1. The printing calculator paper with sticky adhesive backing will come in standard size rolls of 2¼″ width with various lengths such as 10 feet, 50 feet, and 100 feet. The paper will fit into and work with commonly available printing calculators including brands such as Victor, Sharp, Canon, Casio, Royal, Monroe, Innovera, Compucessory, and others. The back of the paper will have a continuous strip of non-permanent sticky adhesive. When the calculator user tears the paper from the printing calculator, the paper can be adhered to multiple surfaces including paper, wood, plastic, walls, books, desks, folders, computer screens, and others.
